(19) United States
(12) Patent Application Publication
(10) Pub. No.: US 2014/0140525 A1
(43) Pub. Date: May 22, 2014

(54) SOUND OUTPUT DEVICE

(71) Applicant: Konica Minolta, Inc., Chiyoda-ku (JP)

(72) Inventors: Masayuki Satou, Toyohashi-shi (JP); Shoichi Yoshikawa, Okazaki-shi (JP); Shigeru Tashiro, Toyokawa-shi (JP); Kuniya Matsuura, Toyohashi-shi (JP); Masahiro Yamaguchi, Toyokawa-shi (JP)

(73) Assignee: Konica Minolta, Inc., Chiyoda-ku (JP)

(21) Appl. No.: 14/083,498

(22) Filed: Nov. 19, 2013

(30) Foreign Application Priority Data
Nov. 19, 2012 (JP) 2012-252945

(51) Int. Cl. G10K 11/175

(52) U.S. Cl. CPC G10K 11/175
USPC 381/71.3

(57) ABSTRACT

A sound output device to be mounted in equipment, the device comprises: a memory unit configured to store correction information for at least one from among date, day and time; a sound reproducing unit configured to reproduce a sound signal representing an additional sound for an operation sound of the equipment, to read, from the memory unit, correction information corresponding to at least one of the current date, day, and time from the memory unit, and to then output a reproduced sound signal after correcting its sound pressure level in accordance with the correction information being read; and a sound output unit configured to emit the additional sound based on the sound signal outputted by the sound reproducing unit.

This application is based on Japanese Patent Application No. 2012-252945 filed on Nov. 19, 2012, the content of which is incorporated herein by reference.

### BACKGROUND OF THE INVENTION

1. Field of the Invention

The present invention relates to a sound output device that emits a sound (called a masker, a masking sound, or the like) that can mask an operation sound (i.e., noise) from equipment.

2. Description of Related Art

Conventionally, to deal with an operation sound generated by equipment such as a multifunction peripheral (MFP), a so-called “noise reduction technology” for reducing operation sounds is employed. Noise reduction lowers the sound pressure level of operation sounds, but does not completely solve problems of people around the equipment experiencing “harshness” and “discomfort” caused by operation sounds.

There is a sound masking technology as a technology to reduce harshness, etc. Sound masking is a phenomenon (sound masking effect) in which perception of a sound at a certain level makes other sounds less audible, and it is mainly classified into frequency masking and temporal masking. The sound masking technology causes a masking sound mainly similar in frequency band to an operation sound to be superimposed with the operation sound. As a result, the operation sound is made less audible, thereby reducing harshness, etc.

As a conventional sound output device applying the sound masking technology, there is a noise masking device described in Japanese Patent Laid-Open Publication No. 9-193506. This noise masking device includes a sound generator for generating a masking sound for an operation sound from equipment, and a masking sound control unit for controlling the sound generator to generate a masking sound within a frequency range including the main component frequency of the operation sound. The masking sound control unit allows the masking sound to be generated within a frequency range between the lower and upper limits of a critical frequency band for the main component frequency of noise.

Incidentally, when the space in which equipment is installed is changed, the level (vibrancy) and the audibility of noise change. For example, placing the equipment in a large space with few surrounding objects results in low reverberation, so that noise and a masking sound are not amplified significantly. On the other hand, placing the equipment in a small space with a number of surrounding objects results in high reverberation due to reflections, so that noise and a masking sound are amplified.

Furthermore, even in the same space, when the number of people around the equipment changes, the level of background noise changes. As the result, the audibility of the masking sound itself changes. For example, when there is no one around the equipment, background noise is low, and therefore, the masking sound itself might sound harsh.

As described above, there are problems in that the masking effect varies in accordance with reverberation in the space where the equipment is installed, and the masking sound itself might cause varying levels of harshness depending on background noise in the installation space.

### SUMMARY OF THE INVENTION

In an embodiment of the present invention, a sound output device to be mounted in equipment, the device includes: a memory unit configured to store correction information for at least one from among date, day and time; a sound reproducing unit configured to reproduce a sound signal representing an additional sound for an operation sound of the equipment, to read, from the memory unit, correction information corresponding to at least one of the current date, day, and time from the memory unit, and to then output a reproduced sound signal after correcting its sound pressure level in accordance with the correction information being read; and a sound output unit configured to emit the additional sound based on the sound signal outputted by the sound reproducing unit.

### BRIEF DESCRIPTION OF THE DRAWINGS

FIG. 1 is a schematic diagram illustrating the internal configuration of an image forming apparatus in which a sound output device according to an embodiment is mounted;

FIG. 2 is a block diagram illustrating in detail the configuration of the sound output device in FIG. 1;

FIG. 3 is a graph showing the basic concept of masking;

FIG. 4 is a graph showing frequency characteristics of noise and a masking sound for installation spaces with different reverberation time;

FIG. 5 is a graph showing characteristics of sound pressure levels of noise and a masking sound versus reverberation time;

FIG. 6A is a graph showing changes in background noise over time in an office mainly used for sedentary work;

FIG. 6B is a graph showing changes in background noise over time in a sales branch;

FIG. 7 is a table showing the length of reverberation time and the level of background noise for each time slot in an installation space;

FIG. 8 is a diagram showing the contents of correction tables;

and

FIG. 9 is a flowchart illustrating the operation of the sound output device in FIG. 2.

### DETAILED DESCRIPTION OF THE PREFERRED EMBODIMENTS

### Embodiment

Hereinafter, a sound output device according to an embodiment of the present invention will be described in detail with reference to the drawings. In the following, an image forming apparatus in which the sound output device is to be mounted will be described first.

### Preliminary Note

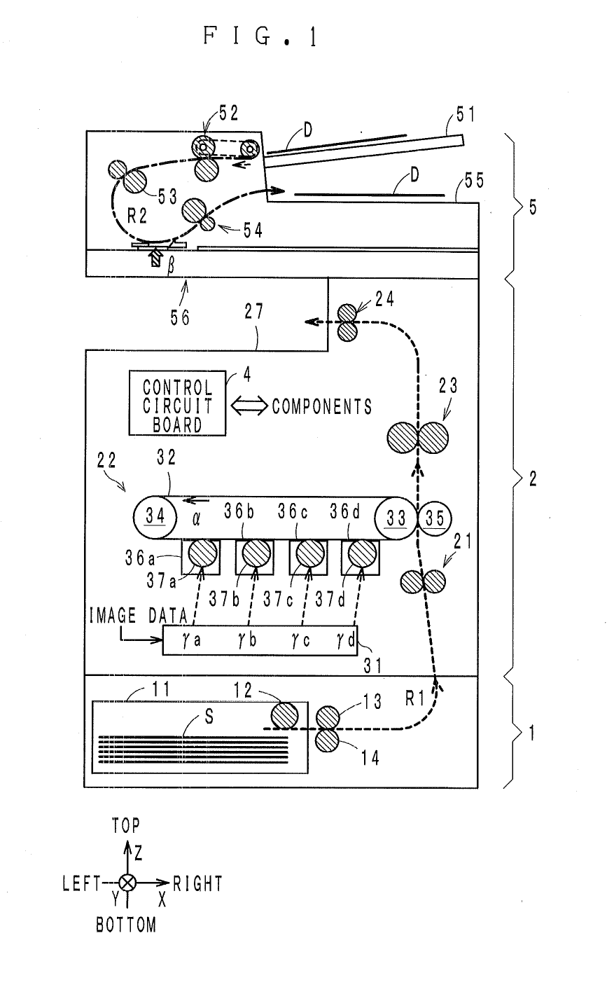

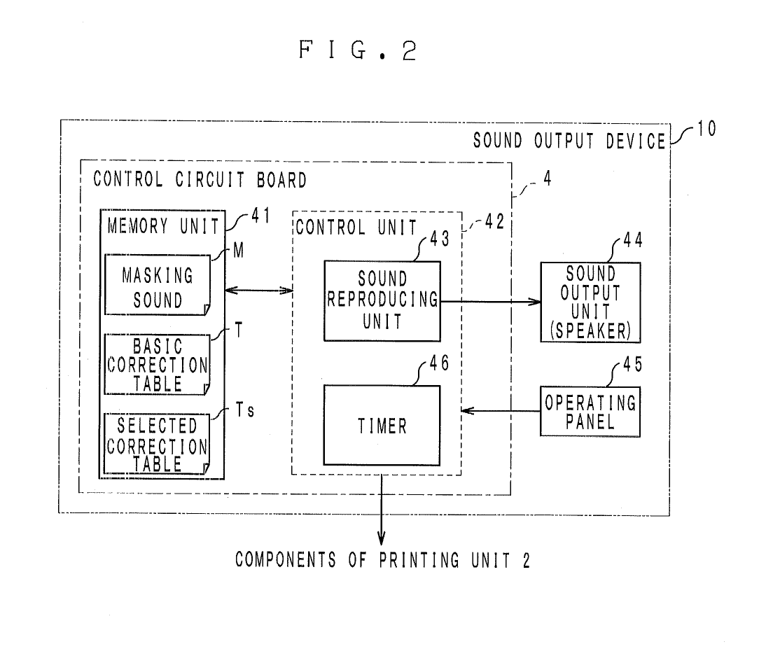

The X-, Y-, and Z-axes in FIGS. 1 and 2 will now be defined. The X-, Y-, and Z-axes represent the left-right, front-back, and top-bottom directions of the image forming apparatus. Moreover, for some components in FIG. 1, the suffix a, b, c, or d is assigned to the right of their reference numerals. The suffixes a, b, c, and d represent yellow (Y), magenta (M), cyan (C), and black (Bk), respectively. For example, a photoreceptor drum 37a refers to a photoreceptor drum 37 for yellow. Moreover, any reference numeral without a suffix is intended to mean any of the colors Y, M, C, and Bk. For example, a photoreceptor drum 37 is intended to mean a photoreceptor drum 37 for any one of the colors Y, M, C, and Bk.

### Configuration and Operation of Image Forming Apparatus

The image forming apparatus is installed in, for example, an office-like environment, and includes at least a supply unit 1 and a printing unit 2. Moreover, the image forming apparatus can optionally include peripheral devices such as an automatic document feeder (ADF) and a finisher. In the example shown in FIG. 1, an ADF 5 is additionally included.

Once a printing process starts, a pickup roller 12 in the supply unit 1 takes up sheets S stacked in a supply tray 11, one by one from the top of the stack. Each of the sheets S taken from the stack is sequentially fed by a supply roller 13 and a separation roller 14 into a transportation path R1 (see a dotted line).

In the printing unit 2, a paper stop roller pair 21 forms a registration nip. The paper stop roller pair 21 is initially at rest, so that the sheet S fed into the transportation path R1 by the supply unit 1 contacts the registration nip and temporarily stops moving. The paper stop roller pair 21, under control of a control unit 42 (to be described later), starts rotating with the timing that matches secondary transfer to be described later, thereby causing the sheet S having temporarily stopped to be forwarded downstream in the transportation path R1.

Furthermore, the printing unit 2 has an imaging unit 22 provided immediately downstream from the paper stop roller pair 21 in the transportation path R1, and the imaging unit 22 includes an optical scanning device 31, an intermediate transfer belt 32, a drive roller 33, a driven roller 34, a secondary transfer roller 35, and image generating units 36 for their respective colors. Each of the image generating units 36 for the colors includes a photoreceptor drum 37 adapted to be rotatable.

Upon input of image data, the optical scanning device 31 generates an optical beam γ for each color, and scans the outer circumferential surface of the photoreceptor drum 37 corresponding to that color. As a result, an electrostatic latent image in the corresponding color is generated on the outer circumferential surface. Thereafter, the electrostatic latent image is developed by a developer (not shown) for each color, so that a toner image in the corresponding color is generated.

The intermediate transfer belt 32 is an endless belt stretched around rollers 33 and 34, and rotates in the direction of arrow a. The toner images supported on the photoreceptor drums 37 are sequentially transferred onto the same area of the intermediate transfer belt 32 (primary transfer), so that the toner images in their respective colors are superimposed onto one another, resulting in a composite toner image. The composite toner image is carried toward the secondary transfer roller 35 through rotation of the intermediate transfer belt 32.

The secondary transfer roller 35 contacts the intermediate transfer belt 32, thereby forming a secondary transfer nip. The sheet S fed by the paper stop roller pair 21 is introduced into the secondary transfer nip. A transfer voltage is applied to the secondary transfer roller 35, so that the composite toner image on the intermediate transfer belt 32 is subjected to secondary transfer onto the sheet S passing through the secondary transfer nip. The secondary transfer roller 35 and the intermediate transfer belt 32 feed the sheet S having received secondary transfer, downstream in the transportation path R1.

A fuser 23 includes a heating roller and a pressure roller, and these rollers form a fixing nip. The sheet S forwarded from the secondary transfer nip passes through the fixing nip. The sheet S is heated and pressed while it is passing through the fixing nip, so that the composite toner image is fixed on the sheet S. Thereafter, the fuser 23 feeds the sheet S toward an ejection roller pair 24 provided downstream in the transportation path R1.

When the sheet S having the image fixed thereon is introduced from the fuser 23, the ejection roller pair 24 ejects the sheet S into an output tray 27.

### Configuration of ADF

As described above, the image forming apparatus is provided with the ADF 5. The ADF5 is provided with a tray 51 in which documents D can be placed. A supply unit 52 is provided in order to feed the documents D one by one from the tray 51 into a transportation path R2 (see a long dashed short dashed line).

A paper stop roller pair 53 is provided in order to form a registration nip in the ADF5. The paper stop roller pair 53 is initially at rest, so that a document D fed into the transportation path R2 by the supply unit 52 contacts the registration nip and temporarily stops moving. Thereafter, the paper stop roller pair 53 starts rotating under timing control by the control unit 42 (to be described later), thereby causing the document D fed into the transportation path R2 by the supply unit 52 to be forwarded further downstream (specifically, to a reading position β). An ejection roller pair 54 ejects the document D having passed the reading position β, into an output tray 55.

A document reading unit 56 is fixed directly below the reading position β, in order to read the document D sequentially, line by line, when the document D passes the reading position β. Specifically, the document reading unit 56 has a light emitting element that emits light toward the reading position β. The light is reflected by the document D so as to enter an imaging lens via a plurality of mirrors, and ultimately form an image on an image pickup element. The image pickup element performs photoelectric conversion to sequentially generate image data for a line in the document D based on the entering light, and outputs the data to the control unit 42 in the printing unit 2.

Furthermore, the image forming apparatus includes a control circuit board 4 for controlling various components (including the ADF 5). The control circuit board 4 includes a memory unit 41 and the control unit 42, as shown in FIG. 2. The memory unit 41 is flash memory or suchlike, and has various data stored therein. Moreover, the control unit 42 is a CPU, ROM, RAM, or the like, and controls the components as mentioned above.

### Configuration of Sound Output Device

The image forming apparatus further includes a sound output device 10, as shown in FIG. 2. To emit a masking sound for noise (an operation sound) generated by the image forming apparatus in FIG. 1, the sound output device 10 includes the memory unit 41, a sound reproducing unit 43 implemented by the CPU of the control unit 42 executing software, a sound output unit 44 consisting of at least one speaker, an operating unit 45, and a timer 46.

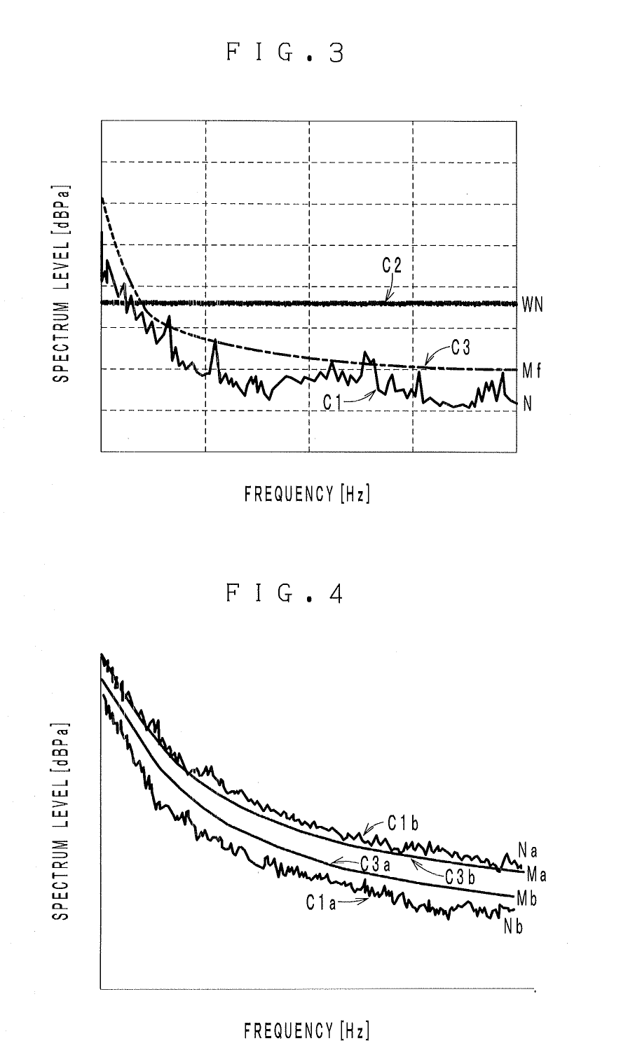

First of all, the memory unit 41 has sound data representing a masking sound M stored therein as data to be used by the sound reproducing unit 43. The masking sound M is an artificial sound obtained by, for example, processing the frequency characteristic of an environmental sound so as to have a frequency characteristic resembling that of noise made by the image forming apparatus alone or in combination with a peripheral device. Moreover, the masking sound M normally carries no meaning to the user. Although the basic concept of masking is well known, it will be described in detail below with reference to FIG. 3.

In FIG. 3, curve C1 indicates a frequency characteristic of noise N made by the image forming apparatus, etc. Further, curve C2 indicates a frequency characteristic of so-called white noise WN whose spectrum level is approximately constant regardless of the frequency. Furthermore, curve Mf indicates a frequency characteristic of a masking sound M for the noise N.

When the noise N is superimposed on the white noise WN, the noise N leaves harshness in the ears of an observer. On the other hand, when the masking sound M having a sound pressure level greater than or equal to that of the noise N is superimposed on the noise N, such harshness can be significantly reduced by a sound masking effect. Such a sound masking effect is increased by raising the masking sound M. However, raising the masking sound M increases the sound generated by the image forming apparatus. The sound itself might become harsh. Therefore, the masking sound M is preferably at the same sound pressure level as the noise N (e.g., about 1 dB higher than the sound pressure level of the noise N). The sound pressure level of the masking sound M that is greater than or equal to that of the noise N will be referred to below as a standard sound pressure level.

The manufacturer of the image forming apparatus obtains the noise N described above, for example, by running the image forming apparatus before shipment. The manufacturer generates a masking sound M that changes over time in a corresponding manner to the obtained noise N and has a standard sound pressure level, and the generated masking sound M is stored to the memory unit 41 in the form of sound data.

The sound output device 10 corrects the sound pressure level of a sound signal reproduced by the sound reproducing unit 43 to be described later. To this end, the memory unit 41 has a basic correction table T stored therein, in addition to data for the masking sound M. The basic correction table T will be described below.

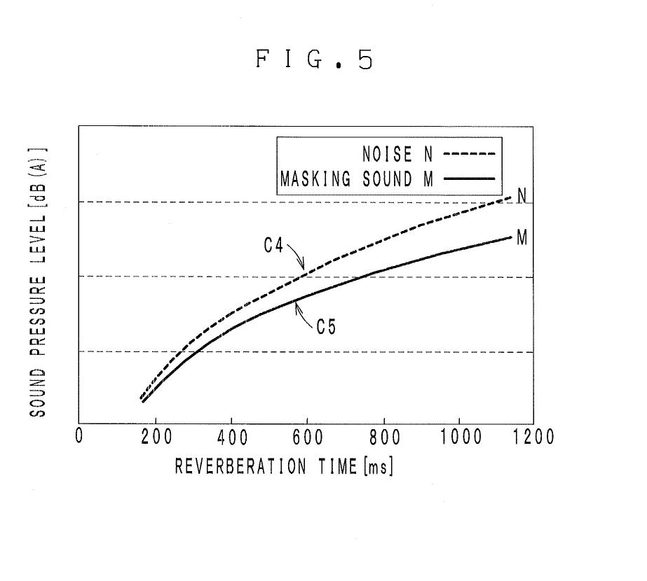

The space (e.g., an office) in which the image forming apparatus is installed varies in size and shape, and various objects (e.g., desks) are placed around the image forming apparatus. Moreover, the number of people around the image forming apparatus varies among different installation spaces. Due to these factors, reverberation time varies among different installation spaces. The present inventors obtained the results shown in FIG. 4 by actually measuring frequency characteristics where the same noise N and masking sound M were emitted in installation spaces with different reverberation time.

In FIG. 4, curves C1a and C3a represent frequency characteristics of the noise N and the masking sound M where reverberation time is short. Curves C1b and C3b represent frequency characteristics of the noise N and the masking sound M where reverberation time is long. It can be appreciated that, in the example shown in FIG. 4, the installation space with long reverberation time amplified the noise N and the masking sound M more than the installation space with short reverberation time.

From the above, it can be appreciated that, even when the image forming apparatus emits the same sound, if the reverberation time of the installation space varies, the frequency characteristic (audibility) of the sound changes. Furthermore, the installation space with short reverberation time keeps the sound pressure level of the masking sound M (see curve C3a) higher than the sound pressure level of the noise N (see curve C1a), so that an appropriate sound masking effect can be achieved. However, the installation space with long reverberation time renders the sound pressure level of the noise N (see curve C1b) higher than the sound pressure level of the masking sound M (see curve C3b), resulting in a reduced sound masking effect.

FIG. 5 is referenced now. In FIG. 5, curves C4 and C5 represent characteristics of the sound pressure levels of the noise N and the masking sound M versus reverberation time. As shown in FIG. 5, in the case of the installation space with short reverberation time, the noise N and the masking sound M are approximately equal in sound pressure level, or if not, the different therebetween is small. However, as the reverberation time becomes longer, the difference in the degree of amplification between the noise N and the masking sound M increases. As for the installation space with long reverberation time in the example shown in FIG. 5, the degree of amplification of the noise N is relatively high, so that the sound masking effect is conceivably reduced. In such a case, to achieve an appropriate sound masking effect, it is necessary to raise the sound pressure level of the masking sound M by a predetermined value.

Note that in the example shown in FIG. 5, the noise N is amplified significantly in the environment with long reverberation time. However, as opposed to the example shown in FIG. 5, the masking sound M might be amplified more significantly even in the installation space with long reverberation time, depending on, for example, the configuration of the image forming apparatus and the speaker. In such a case, the masking sound M itself might be harsh, and therefore, it is preferable to lower its sound pressure level by a predetermined value.

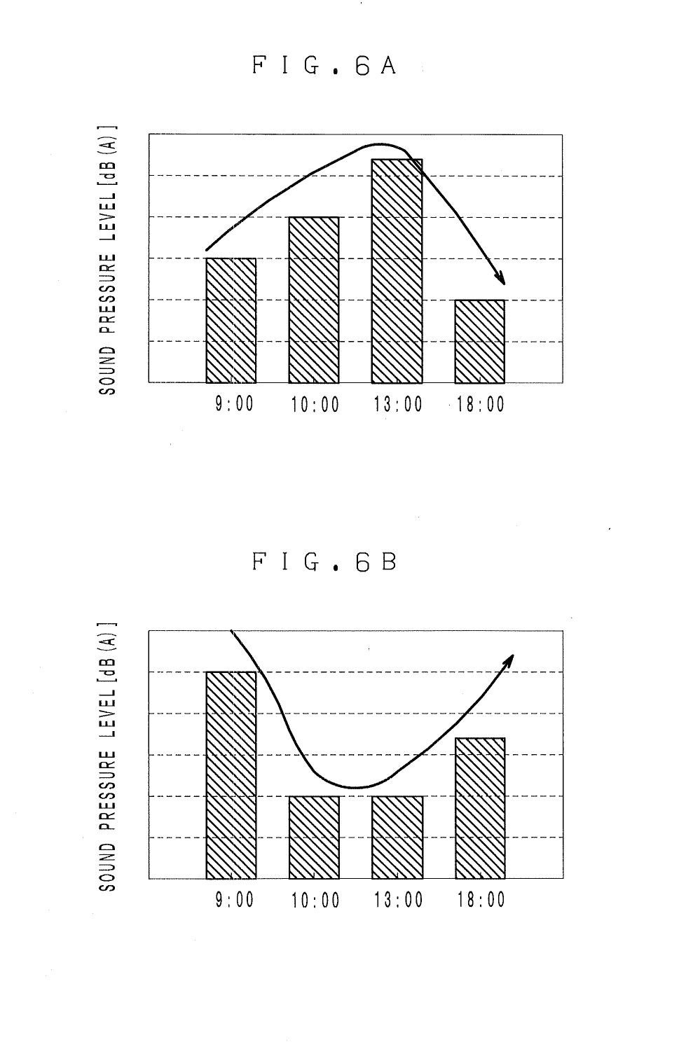

Furthermore, temporal variations in the sound pressure level of background noise (e.g., conversational voices) vary among spaces (e.g., offices) in which image forming apparatuses are installed. Specifically, in an office mainly used for sedentary work, the sound pressure level of background noise is high during office hours (e.g., from 9:00 hrs to 17:00 hrs), as shown in FIG. 6A. On the other hand, in a sales branch or suchlike where a number of workers are out of office during office hours, the sound pressure level of the background noise is high approximately before and after office hours (e.g., around 9:00 hrs and 18:00 hrs), as shown in FIG. 6B. Depending on the background noise as described, some workers around the image forming apparatus might perceive the masking sound M itself to be harsh. Specifically, as the difference in the sound pressure level between the masking sound M and the background noise increases, the degree of harshness of the masking sound M tends to become higher.

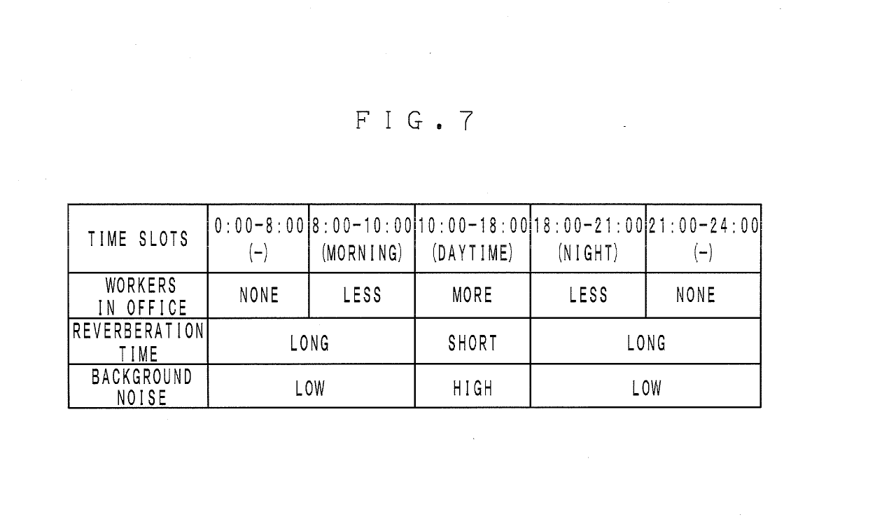

FIG. 7 is a table exemplifying reverberation time and background noise in an office for each time slot. In the example shown in FIG. 7, during the morning time slots (earlier than 10:00 hrs) and the night time slots (later than 18:00 hrs), less workers are in office, so that the reverberation time is long, and the background noise is low. Moreover, during the daytime time slot (from 10:00 hrs to 18:00 hrs), more workers are in office, so that the reverberation time is short, and the background noise is high.

The masking sound M is created at the standard sound pressure level equivalent to the sound pressure level of the noise N, as described above. However, as is apparent from the foregoing, depending on the reverberation time and/or the background noise, it might be preferable to adjust the sound pressure level of the masking sound M. To support such a level adjustment, the memory unit 41 has at least one basic correction table T stored therein. The basic correction table T describes correction information for at least one from among date, day, and time.

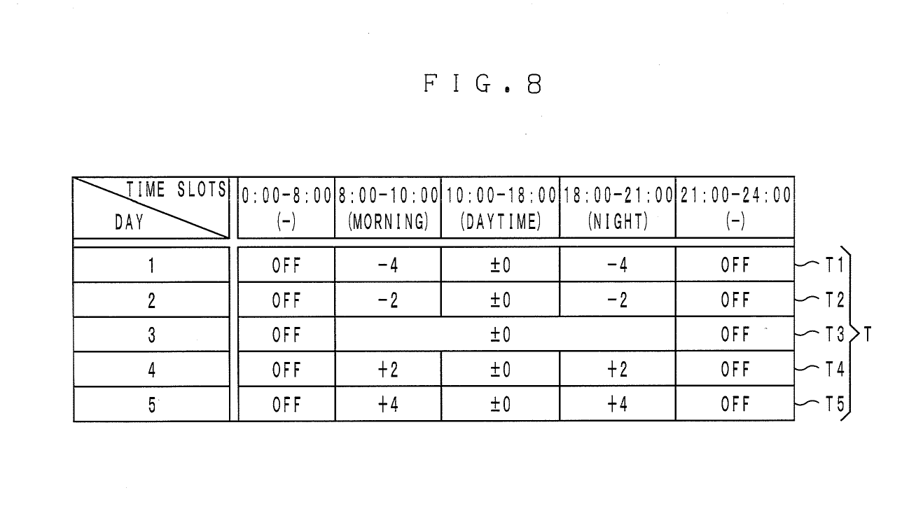

In the present embodiment, five basic correction tables T1 to T5 are prepared, as shown in FIG. 8. Each of the basic correction tables T1 to T5 describes items of correction information, each item being correlated in a one-to-one correspondence with one of five time slots into which a day is divided. For example, the basic correction table T1 describes that the sound pressure level correction is off during the time slot from 0:00 hrs to 8:00 hrs and the time slot from 21:00 hrs to 24:00 hrs. Moreover, it is also described that the sound pressure level is set 4 dB lower than the standard sound pressure level during the time slot from 8:00 hrs to 10:00 hrs and the time slot from 18:00 hrs to 2100 hrs. In addition, it is also described that the sound pressure level is set ±0 dB from the standard sound pressure level during the time slot from 10:00 hrs to 12:00 hrs.

Note that FIG. 8 exemplifies the basic correction tables T1 to T5 each describing that a standard masking sound M is emitted during the daytime time slot, and a masking sound M adjusted for sound pressure is emitted during both the morning and the night time slot. However, this is not restrictive, and there may be stored a basic correction table describing that a masking sound M adjusted for sound pressure is emitted during the daytime time slot, and a masking sound M with standard sound pressure is emitted during both the morning and the night time slot.

Next, the operation of the sound output device 10 will be described. The following setting operation is performed initially at the time of installation of the image forming apparatus and on other occasions when necessary. In this setting operation, a user or suchlike manipulates the operating panel 45, which is a touch panel or suchlike, to set the current date, day and time for the timer 46. Moreover, the user or suchlike displays the basic correction tables T1 to T5 on a display portion of the operating panel 45, and selects one table that is suitable for the installation space of the image forming apparatus (more specifically, conditions such as reverberation time and background noise). Such a selected table will be referred to below as a selected correction table Ts.

Note that at the time of the setting operation, a selected correction table Ts may be set for each specific day. Moreover, the start and the end of each time slot may be changed suitably. In addition, the user may set correction information by preference. While the operating panel 45 in the present embodiment has been described as a touch panel, the user may perform the setting operation using, for example, a personal computer connected to the image forming apparatus via a network.

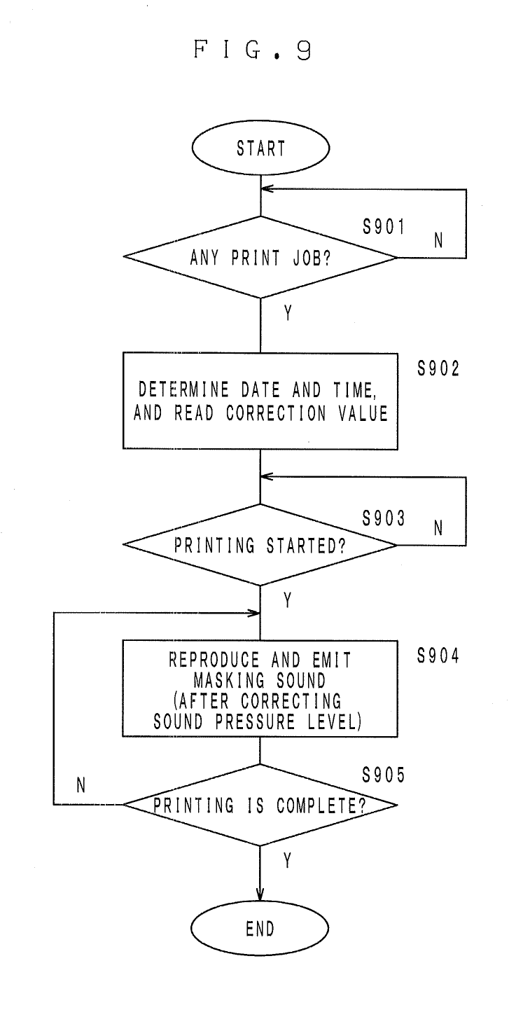

Furthermore, upon reception of a print job (S901 in FIG. 9), the sound reproducing unit 43 acquires the current time (with date and day) from the timer 46. Thereafter, the sound reproducing unit 43 accesses the memory unit 41 and reads correction information correlated with the acquired current time from the selected correction table Ts (S902).

Here, upon reception of the print job, the control unit 42 of the image forming apparatus controls various components of the image forming apparatus, thereby executing the printing. Once the printing starts (S903), the sound reproducing unit 43 reproduces data being read from the memory unit 41, thereby reproducing a sound signal that represents a masking sound M. Thereafter, the sound reproducing unit 43 corrects the reproduced sound signal on the basis of the correction information having been read in step S902. If the correction information indicates +4 dB, the sound pressure level of the reproduced sound signal is raised by 4 dB. The sound reproducing unit 43 outputs the corrected sound signal to the sound output unit 44. The sound output unit 44 emits the masking sound M in accordance with the received sound signal (S904). The processing of S904 is executed until the printing process is determined to be complete in S905.

### Effects and Actions of Sound Output Device

As described above, the basic correction tables T1 to T5 are prepared for the sound output device 10. The user or suchlike selects a table suitable for the installation space of the image forming apparatus from among the basic correction tables T1 to T5, thereby deciding correction information to be used in correcting the sound pressure level of a sound signal. The sound output device 10 corrects the sound pressure level of the sound signal based on such correction information, and emits a masking sound M. As a result, it is rendered possible to provide a sound output device 10 capable of achieving a suitable sound masking effect for each installation space.

### Supplementary

The user or suchlike may manipulate the operating panel 45 to provide an instruction to add a new basic correction table to the memory unit 41 or an instruction to edit a basic correction table T stored in the memory unit 41. In response to this, the control unit 42 adds a new basic correction table stored in an external storage medium, such as a USB storage device, to the memory unit 41 or edits a basic correction table T stored in the memory unit 41 on the basis of information inputted to the operating panel 45.

In response to the user or suchlike manipulating the operating unit 46, the control unit 42 may set the date, day or time at which no correction based on the correction information is performed.

Furthermore, the above embodiment has been described with respect to the example where the sound output device 10 emits the masking sound M. However, this is not restrictive, and the sound output device 10 may emit background music while the image forming apparatus is in operation. Specifically, the sound output device 10 may emit an additional sound to be superimposed on an operation sound made by a printing process.

Furthermore, the present embodiment has exemplified only the masking sound M for the image forming apparatus. However, this is not restrictive, and a masking sound M for noise made by the ADF 5 in operation may be produced. Moreover, the sound output device 10 may control the sound pressure level of the masking sound M for the ADF 5.

Although the present invention has been described in connection with the preferred embodiment above, it is to be noted that various changes and modifications are possible to those who are skilled in the art. Such changes and modifications are to be understood as being within the scope of the invention.

What is claimed is:

1. A sound output device to be mounted in equipment, comprising:
a memory unit configured to store correction information for at least one from among date, day and time;
a sound reproducing unit configured to reproduce a sound signal representing an additional sound for an operation sound of the equipment, to read, from the memory unit, correction information corresponding to at least one of the current date, day, and time, and to then output a reproduced sound signal after correcting its sound pressure level in accordance with the correction information being read; and
a sound output unit configured to emit the additional sound based on the sound signal outputted by the sound reproducing unit.

2. The sound output device according to claim 1, wherein,
the memory unit is configured to store a plurality of correction tables each having correction information for at least one from among date, day, and time, the correction information in respective correction tables being different from one another,
the sound output device further includes a first operating unit configured to be manually operated to specify one of the correction tables stored in the memory unit, and
the sound reproducing unit is configured to read correction information corresponding to at least one of the current date, day, and time from the correction table specified via the first operating unit, and to then output a reproduced sound signal after correcting its sound pressure level in accordance with the correction information being read.

3. The sound output device according to claim 1, further comprising a second operating unit configured to be manually operated to provide an instruction to add new correction information to the memory unit or an instruction to edit the correction information stored in the memory unit.

4. The sound output device according to claim 1, further comprising a third operating unit configured to be manually operated to specify the date, day, or time at which no correction based on the correction information is performed.

5. The sound output device according to claim 1, wherein,
the memory unit is configured to store at least first and second correction tables having correction information for first and second days, and
the sound reproducing unit is configured to read correction information from one of the first and second correction tables in accordance with the current day, and to then output a reproduced sound signal after correcting its sound pressure level in accordance with the correction information being read.

6. The sound output device according to claim 1, wherein the additional sound is a sound capable of masking an operation sound of the equipment.

7. The sound output device according to claim 1, wherein the equipment includes an image forming apparatus and a peripheral device thereof.
